(19) United States
(12) Patent Application Publication
(10) Pub. No.: US 2021/0304515 A1
(43) Pub. Date: Sep. 30, 2021

(54) Systems and Methods of User Controlled Viewing of Non-User Avatars

(71) Applicant: Wormhole Labs, Inc., Huntington Beach, CA (US)

(72) Inventors: Curtis Hutten, Laguna Beach, CA (US); Robert D. Fish, Irvine, CA (US); Brian Kim, Walnut, CA (US)

(21) Appl. No.: 16/831,589

(22) Filed: Mar. 26, 2020

(51) Int. Cl. G06T 19/20; G06T 19/00; G06T 13/40; H04W 4/029; H04W 4/021

(52) U.S. Cl. CPC G06T 19/20; G06T 19/006; G06T 2219/024; H04W 4/029; H04W 4/022; G06T 13/40

(57) ABSTRACT

In a method modifying a user's virtual environment, a filtration module receives an avatar filtration parameter, updates location parameters with the avatar filtration parameter, and determines a physical target area about the user. The filtration module identifies an avatar of a second user in the target area and determines whether the avatar meets the avatar filtration parameter. Responsive to determining that the avatar does not meet at least one of the avatar filtration parameters, the filtration module modifies the avatar to comply with all of the avatar filtration parameters.

### FIELD OF THE INVENTION

The field of the invention is management of mixed reality environments.

### BACKGROUND

The inventive concepts herein aim to integrate combinations of augmented reality spaces, interactive objects, and virtual reality spaces to dynamically tailor environments based the local environmental context of the user.

Specifically, the present invention enables individuals to enter into the augmented reality spaces of others and interact with others, while the appearance of other avatars and the local environment change based on user preferences. For example, the present invention contemplates filtering out particular avatars out of a crowded space. In a more specific example, a user could filter out all avatars in an augmented reality powered concert and see “through” the crowd to locate their friends' locations in a three-dimensional walkabout reality.

The present invention further contemplates changing the appearance of one or more avatars based on user preferences. For example, a user, such as a color-blind user, can choose to change the colors of clothing on avatars within their local environmental context.

U.S. Pat. No. 7,925,703 to Dinan teaches an avatar based interactive environment in which users can customize their own avatars. Dinan fails to modify a user walkabout reality environment by filtering out and changing one or more avatar and/or environmental elements.

U.S. Pat. No. 7,155,680 to Akazawa teaches a variable virtual world based on the displays that show customized information particular to each user's needs. However, Akazawa merely contemplates the projection of information on relatively static objects and users. Akazawa fails to contemplate a modification of the avatars in a user's target area and the removal or diminishing of non-user avatars from the view of the user.

In gaming, it is generally known that players can move between virtual spaces by teleporting. However, these game worlds are largely tied to predetermined structures, limited customization specific to the game, and linked to other preselected areas. For example, a game such as The Sims™ allows users to engage with each other in a shared virtual space with each home built and accessorized using an in-game engine. Unlike The Sims™, the inventive concept herein contemplates a highly customizable mixed reality space that can link to any number of other customized mixed reality spaces. The present invention also contemplates enabling users to tie customizable functions, avatar appearances, and environmental features/effects.

Dinan, Akazawa, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for mixed reality system infrastructures that can customize user augmented realities and avatar characteristics dynamically based on the changing context of a user's current environment.

### SUMMARY OF THE INVENTION

The inventive concept herein contemplates virtual reality, augmented reality, and/or mixed reality environments that are highly customizable with various interactive elements. It is contemplated that the interactive elements can be at least partially customized by a filtration module associated with the mixed reality space. It is further contemplated that the filtration module can filter and edit and remove avatars and environmental features based on avatar filtration parameters.

The present invention contemplates that the filtration module can receive an avatar filtration parameter, update the location parameters with the avatar filtration parameter, and determine a physical target area about the user based on the avatar filtration parameters and the location parameters. The filtration module then identifies an avatar of a second user in the target area and determines whether the avatar meets the avatar filtration parameter. If an avatar does not meet at least one of the avatar filtration parameters, the filtration module modifies the avatar to comply with all of the avatar filtration parameters. In some instances, the filtration module can remove or diminish avatars from a user's perspective to quickly isolate and present key avatars to the user.

Modification to the user's virtual environment are contemplated to include both environmental features as well as the features associated with the user. For example, the user's virtual environment can include both the actual surroundings and the appearance of the user's avatar.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a schematic of a method of retrieving location parameters associated with a user.

FIG. 3 is a schematic of a method of filtering non-user avatars and modifying at least one of the non-user avatars and a user environment.

FIG. 4 is a schematic of a method of instantiating one or more avatars based on updated user location parameters.

FIG. 5 is a schematic of a method of modifying at least one of the non-user avatars and a user environment based on updated avatar filtration parameters.

FIG. 6 depicts a block diagram of components of the server computer executing the filtration module 110 within the distributed data processing environment of FIG. 1.

FIG. 7 is a representative diagram illustrating the filtration of users based on location parameters and avatar filtration parameters.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including allowing users to access mixed reality environments. Mixed reality environments can include any combination of virtual and augmented reality environments and can be connected to each other in any manner.

For the purposes of this application, sub-environments can comprise any one or more of an augmented reality, a virtual reality, and any other interactive media format. For example, a primary sub-environment can be a first augmented reality, and a secondary sub-environment can be a second augmented reality connected to the first through a portal.

For the purposes of this application, “portal” or any similar terms, such as “portalling” and “portalled” mean any connected between environments. Portals can be in the form of interactive objects, designated spaces, or any other form that allows a user to connect to other augmented realities and/or virtual realities.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

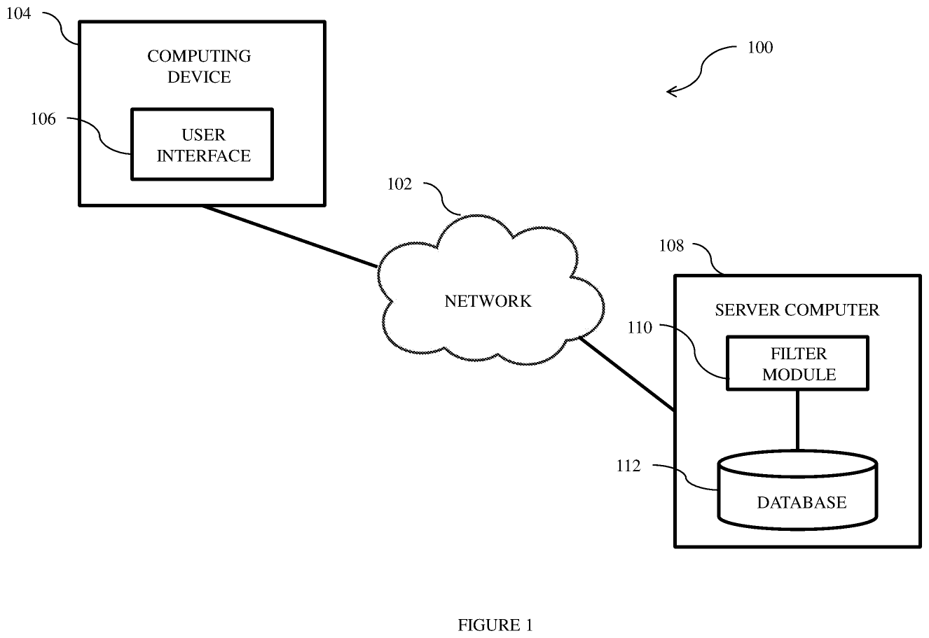

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104, server computer 108, and any other computing devices (not shown) within distributed data processing environment 100.

It is contemplated that computing device 104 can be any programmable electronic computing device capable of communicating with various components and devices within distributed data processing environment 100, via network 102. It is further contemplated that computing device 104 can execute machine readable program instructions and communicate with any devices capable of communication wirelessly and/or through a wired connection. Computing device 104 includes an instance of user interface 106.

User interface 106 provides a user interface to filtration module 110. Preferably, user interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

User interface 106 can allow a user to register with and configure filtration module 110 (discussed in more detail below) to enable a user to access a mixed reality space. It is contemplated that user interface 106 can allow a user to provide any information to filtration module 110.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

Database 112 is a repository for data used by filtration module 110. In the depicted embodiment, filtration module 110 resides on server computer 108. However, database 112 can reside anywhere within a distributed data processing environment provided that filtration module 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

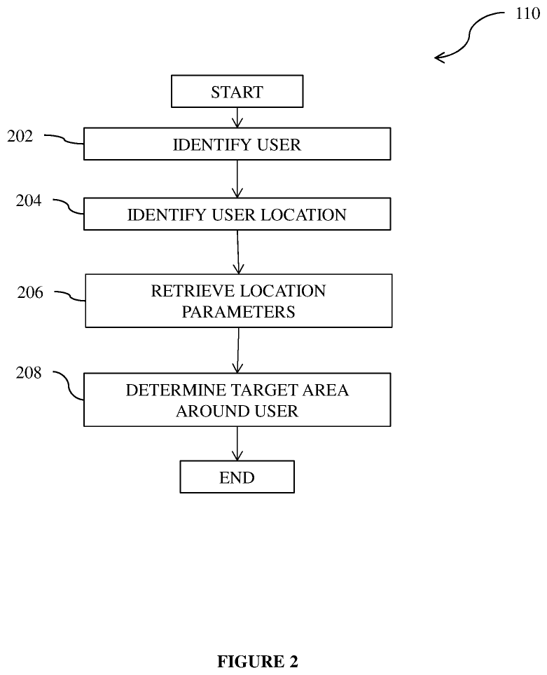

FIG. 2 is a schematic of a method of retrieving location parameters associated with a user.

Filtration module 110 identifies a user (step 302).

Filtration module 110 can identify a user in any manner known in the art. In one embodiment, filtration module 110 identifies a user through a signal sent through computing device 104. For example, filtration module 110 can be tied to software, such as a smart phone app, that can register various user actions, including, but not limited to, purchases, browsing, public posts on social media by the user and/or third-parties, and user subscriptions. It is contemplated that filtration module 110 and any associated software can include various user-controllable parameters to alter how much data is shared with filtration module 110.

In another embodiment, filtration module 110 identifies a user through one or more preselected sources. For example, filtration module 110 can integrate with a social media application, which can receive location information associated with a user when the user makes a social media post through their smartphone.

In another embodiment, filtration module 110 cooperates with one or more hardware functions, such as the accelerometer and a facial recognition camera on a smartphone. In this example, filtration module 110 can identify the user associated with facial recognition software and track the accelerometer to determine whether the user is on the move.

In yet another embodiment, filtration module 110 receives a direct log-in from the user. For example, a user can download an application associated with an augmented reality platform using filtration module 110. When the user logs in and starts using the software, filtration module 110 can directly track one or more types of data associated with the user.

Filtration module 110 determines a user location (step 304).

Filtration module 110 can determine a user location in any manner known in the art.

In one embodiment, filtration module 110 uses hardware to determine the location of a user. For example, filtration module 110 can retrieve information from a global positioning module of a smartphone to determine the location of the user.

In another example, filtration module 110 can triangulate the position of a user based on the user's proximity to one or more cellular towers.

In yet another example, filtration module 110 can determine the proximity of the user to a cluster of other user devices, such as in a music festival where many users are clustered together, to approximate the location of the user.

In another embodiment, filtration module 110 uses software means to determine the location of a user. For example, filtration module 110 can analyze the last social media post of a user to approximate where the user currently is. In a more specific example, filtration module 110 can identify a tag on a social media post of a user indicating the location of the post to be a famous restaurant in the city.

Filtration module 110 retrieves location parameters (step 306).

Location parameters can include any variable associated with the location of the user. Location parameters can include, but are not limited to, a current user location, rules regarding other mixed reality participants, businesses, color schemes, schedules, promotions, and restrictions.

In some embodiments, a location parameter is a rule associated with a characteristic of the location itself. For example, a location within 100 yards of a school can restrict user avatars to those that are classified as appropriate for children 13 years and younger. In another example, a location within a graveyard can restrict auditory messages sent between users and only permit text-based communications.

In other embodiments, a location parameter is a rule associated with a characteristic of a user in the location. For example, a user that is younger than 13 years old can be restricted in a particular location from seeing 18+ content in a mixed reality powered movie theater. In another example, a user that does not have a virtual event ticket can be filtered out and prevented from seeing the augmented reality-based projections on top of green screens in the event area.

In one embodiment, filtration module 110 stores location parameters database 112.

In other embodiments, filtration module 110 remotely stores data using a network of remotely connected computers, such as a cloud computing environment. For example, filtration module 110 can store data stored across multiple computers, such as smartphones. In another example, filtration module 110 can send the data through network 102 to be stored in one or more remote servers. However, filtration module 110 can store location parameters in any medium available in the art.

Filtration module 110 determines a target area around a user (step 308).

A target area can be any definable space about a user. For example, filtration module 110 can define the target area to be a definable space about the user in at least one of a virtual reality, augmented reality, mixed reality, and real-world environment.

In one embodiment, the target area around a user can be a circumferential area about the user. For example, filtration module 110 can define the target area around the user to be a circular area around a user including anything within 500 feet of the user. The space around a user can be defined by any shape, including both conventional volumetric spaces, such as circular, oval, and square spaces, and irregular volumetric spaces, such as a space with inaccessible spaces interspersed within and spaces defined by shapes whose interior angles and sides are not all the substantially the same.

In another embodiment, the target area around a user can be defined by a volumetric space around a user. For example, filtration module 110 can define the target area around the user to a spherical area that includes anything within 500 feet of the user. The volumetric space around a user can be defined by any three-dimensional shape, including both conventional volumetric spaces, such as spherical, conical, and cylindrical spaces, and irregular volumetric spaces, such as a volumetric space with inaccessible volumetric spaces interspersed within.

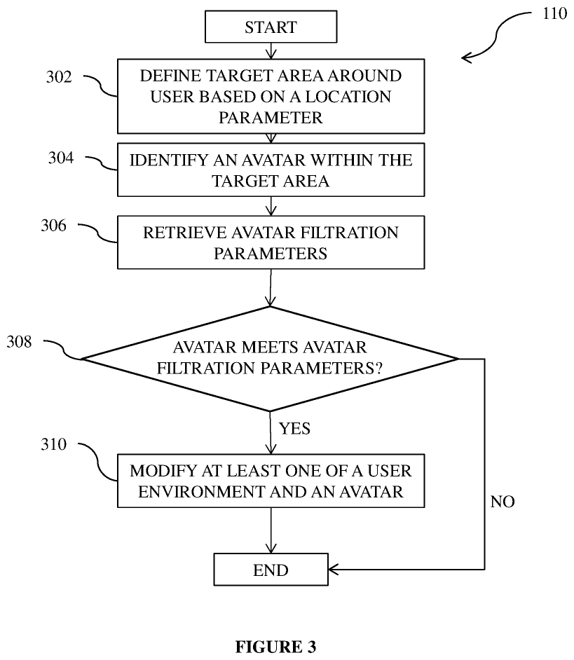

FIG. 3 is a schematic of a method of filtering non-user avatars and modifying at least one of the non-user avatars and a user environment.

Filtration module 110 defines a target area around a user based on a location parameter (step 302).

It is contemplated the present invention can define a target area in any manner known in the art. In some embodiments, the target area is visually defined. For example, a user can see through an augmented reality interface the extent of the user's target area when the target area is an area defined within a 150-foot radius of the user. In another example, a user can see through an augmented reality interface that the target area is confined to the room in which the user is currently located.

In other embodiments, the target area can dynamically change. For example, the location parameter associated with a user can require that there be a minimum number of non-user avatars within a user's target area. In response, filtration module 110 can dynamically adjust the target area to either satisfy a minimum target area around the user or exceed to the minimum target area to include a minimum number of non-user avatars.

Location parameters can set by a user, partially set by a user, preset, or any set using any combination thereof.

Filtration module 110 identifies an avatar within the target area (step 304).

Filtration module 110 can identify one or more avatars within a target area in any manner. For example, filtration module 110 can identify one or more avatars within the target area at one point in time, in response to a change in any situational parameters, periodically, and continuously.

In one embodiment, filtration module 110 identifies one or more avatars in a closed environment. For example, filtration module 110 can solely identify users and their associated avatars that subscribe to a shared social media platform. In another embodiment, filtration module 110 can identify avatars that are affiliated with third-party systems. For example, filtration module 110 can identify users and their respective avatars from other social media networks. In yet another example, filtration module 110 can identify a mix of avatars that are associated with at least one of a shared platform and a third-party platform.

Filtration module 110 retrieves avatar filtration parameters (step 306).

In a preferred embodiment, filtration module 110 receives avatar filtration parameters from a remote database, such as database 112. For example, filtration module 110 can receive data from remote servers operating over a cloud infrastructure. In another example, filtration module 110 can receive data from various remote storage mediums including crowd-stored and crowd-sourced data in a distributed data network.

In other embodiments, filtration module 110 receives avatar filtration parameters from local storage. For example, filtration module 110 can receive avatar filtration parameters from a user's persistent memory on the user's smart phone. In another example, filtration module 110 can receive avatar filtration parameters from direct user input onto the screen such that avatar filtration parameters are submitted prior to each use of filtration module 110.

Filtration module 110 determines whether the avatar meets the avatar filtration parameters (decision block 308).

Filtration module 110 determines whether there are any avatar restrictions and/or allowances that apply to the non-user avatar. Based on the determination, filtration module either allows the non-user avatar to be displayed within the target area, prohibits the non-user avatar from being displayed within the target area, or modifies at least one of the non-user avatar or the environment from the perspective of the user to resolve any conflicts with the avatar filtration parameters.

In a first embodiment, filtration module 110 determines whether there are any appearance modifications available for non-user avatars. For example, filtration module 110 can determine that a non-user avatar should be changed to a less revealing alternative outfit based on the presence of users under 13 years old in the target area. In another example, filtration module 110 can determine that a user environment should be changed to remove or censor virtual and/or augmented reality features in the environment based on the characteristics of the user. In yet another example, filtration module 110 can determine that a non-user avatar and an environment, such as a augmented reality room, should be changed to reflect an avatar from a particular game and a red-color scheme based on a combination of the avatar filtration preferences, such as a preference for a particular faction in a video game, and location parameters (e.g., requiring that half of the avatars in a particular room are randomly placed in a blue team or a red team).

In a related embodiment, filtration module 110 determines which augmented reality effects can be applied to non-user avatars within the target area. For example, filtration module 110 can determine that the avatar filtration parameters prohibit verbal communications within the target area, so filtration module 110 can mute every non-user avatar in the target area and either display texted messages or convert non-user speech to text. In yet another example, a user prone to epileptic seizures can require that any avatars within the user's target area must be switched to a non-dynamic avatar (e.g., a skin with flashing lights) and any virtual skills, such as emotes, that a non-user performs must be modified to remove special effects prone to causing seizures.

Responsive to determining that the avatar does meet the avatar filtration parameters (“YES” branch, decision block 308), filtration module 110 modifies at least one of a user environment and the avatar (step 310).

Avatar filtration parameters can include any rules associated with available modifications to the user's mixed reality environment and/or the viewing of other avatars within the target area. In some embodiments, avatar parameters restrict available avatar modifications based on predetermined rules. For example, filtration module 110 can restrict an avatar modification associated with a video game soldier during times when the users associated with the non-user avatars fails to cross a minimum age threshold. In a related example, filtration module 110 can change the views of each respective user to comply with each user's unique avatar filtration requirements.

In another example, filtration module 110 can restrict an avatar modification associated a video game franchise based on previously determined rights to the intellectual property. In yet another example, filtration module 110 can restrict avatar and environmental modifications for a group of event goers based on the demographics of a religious group, which prohibits followers from viewing drug references and violence.

Responsive to determining that the avatar does not meet avatar filtration parameters (“NO” branch, decision block 308), filtration module 110 ends.

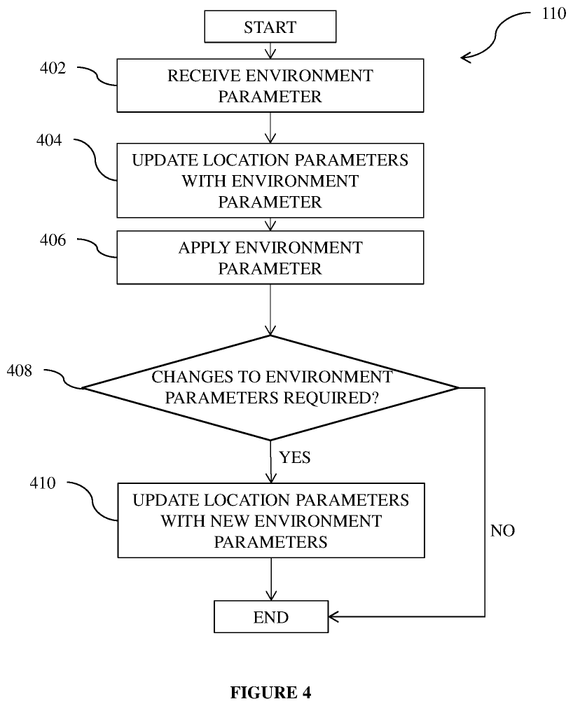

FIG. 4 is a schematic of a method of instantiating one or more avatars based on updated user location parameters.

Filtration module 110 receives an environment parameter (step 402).

Filtration module 110 can receive an environment parameter in any manner and using any medium known in the art.

In one embodiment, filtration module 110 receives the environment parameter from one or more user inputs via user interface 106 of computing device 104. For example, filtration module 110 can receive environment parameters when a user allows his/her location to be provided to filtration module 110 and makes one or more additions or changes to the location parameters.

In other embodiments, filtration module 110 receives the environment parameters in real-time, substantially real-time, and/or periodically captured location parameters associated with a user automatically. For example, computing device 104 can provide data from one or more sensors such that filtration module 110 can automatically determine the best environment parameters based on the location characteristics. In a more specific example, computing device 104 can relay geolocation data, camera images, videos, infrared sensor data, and demographic data to filtration module 110, and, in response, filtration module 110 can apply one or more algorithms to optimize location parameters for a location.

Algorithms can include, but are not limited to, traditional algorithms and machine learning algorithms. Algorithms can be applied to any one or more steps in any manner to assist partially and/or wholly executing any objective. For example, a machine learning algorithm can be applied to historical user data to determine a best color scheme to select for one parameter of a set of location parameters.

In one embodiment, filtration module 110 can analyze historical data and current data only using traditional algorithms. For example, filtration module 110 can analyze the percentage of total play time dedicated to a particular game character to determine which modifications to a user's augmented reality environment to enable and disable particular features in the environment. In another example, filtration module 110 can determine that a location is frequently visited by teenage boys, determine one or more pop culture references most popular with the demographics of the location, and determine via social media data that most of the visitors attend the same school; in response to these determinations, filtration module 110 can determine a particular color scheme, messaging medium, and augmented reality location features to apply to an augmented reality environment.

In another embodiment, filtration module 110 can analyze historical data and current data using machine learning algorithms, which include, but are not limited to, supervised learning classifiers, time-series analysis, and linear regression analysis.

For example, filtration module 110 can predict a change in the environment, such as the basketball league championships, and correspondingly predict that location parameters allowing for purchasable digital goods and emotes for avatars to be temporarily free to use will most effectively bring in more purely virtual avatars and more augmented reality avatars (e.g., where the user is actually in the real world location).

In a more specific example, filtration module 110 can review the historical user comments associated with a professional gamer's streaming videos and predict that the crowd will have a balance of males and females with a preference for a specific character in a video game and correspondingly change the virtual elements of an augmented reality environment to reflect those tastes.

In another example, a linear regression analysis can applied to the user's historical location data to predict what a user will do next (e.g., move to the fighting game section of a gaming convention) and those predictions can be used to apply predicted user parameters and predicted location parameters for the predicted user location in one hour. In a more specific example, a traditional algorithm can look at a user's followers and determine that he/she is famous and associated with a popular game, and a linear regression analysis can determine that the user usually goes to a specific restaurant after a tournament at the current user location. In response, filtration module 110 can update the augmented reality appearance of the restaurant to reflect the user's eSports team colors,

In yet another example, filtration module 110 can determine through current user data and public data that a first team beat a second team in a sporting event that the user is currently attending. By determining through traditional algorithms that the user is a fan of the second team and, through machine learning algorithms, that the user always goes to a particular bar after a loss, filtration module 110 can predict the next environment of the user and tone down the mixed reality of the user to avoid louder sounds and the color scheme of the first team.

Filtration module 110 updates the location parameter (step 404).

Filtration module 110 applies the environment parameters to the user avatar and/or the user environment (step 406).

As discussed above, filtration module 110 can apply any one or more changes to the environment parameters to update the location parameters.

In one embodiment, the one or more changes to the location parameters changes a visual element of the location. For example, filtration module 110 can apply a restriction on advertising a competitor's game in the augmented reality enabled convention for a newly released MMORPG.

Filtration module 110 determines whether one or more changes to the environment parameters are required (decision block 408).

In a first embodiment, filtration module 110 determines whether there are any changes to the environment that will affect the user's walkabout reality environment, such as an augmented reality environment. For example, filtration module 110 can determine whether a user environment should be changed to reflect the environment of a game that is being highlighted at a gaming event, such as making a regular door appear as a castle door for a medieval sword fighting game. In another example, filtration module 110 can determine whether a user's environment should reflect the summer season appearance or the winter season appearance to reflect the time of year and the artwork style of the game.

It is contemplated that the changes to the environment parameters and corresponding changes to the actual user environment can be unique to each user in the environment. It is contemplated that each user in a target area can view the same area in slightly different ways, completely different ways, and any perspective in between.

Responsive to determining that changes to the user environment are required (“YES” branch, decision block 408), filtration module 110 updates the location parameters with the new environment parameters (step 410).

Responsive to determining that changes to the user environment are not required (“NO” branch, decision block 408), filtration module 110 ends.

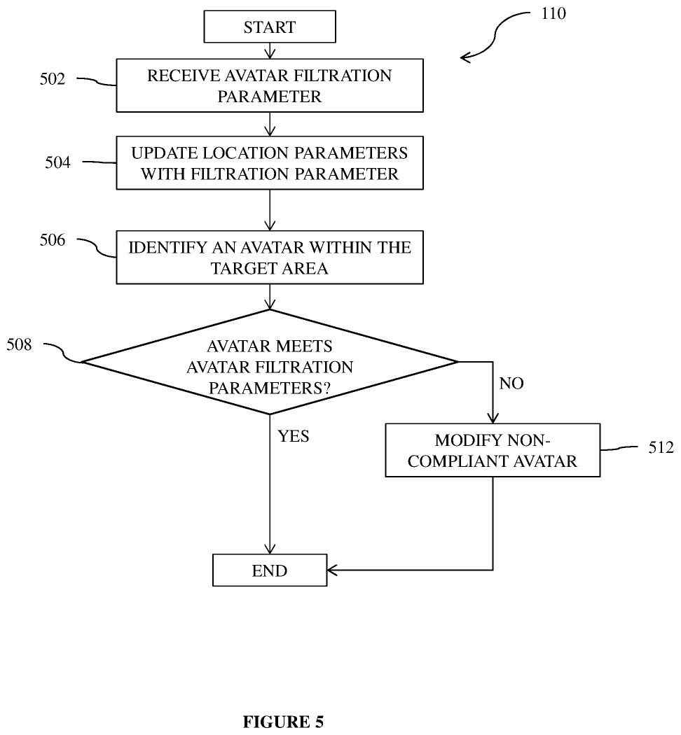

FIG. 5 is a schematic of a method of modifying non-user avatars based on avatar filtration parameters.

Filtration module 110 receives an avatar filtration parameter (step 502).

Filtration module 110 can receive an avatar filtration parameter in any manner and using any medium known in the art.

In one embodiment, filtration module 110 receives the avatar filtration parameter from one or more user inputs via user interface 106 of computing device 104. For example, filtration module 110 can receive avatar filtration parameters when a user inputs one or more restrictions, modifications, and allowances associated with the avatars that the user views in his/her environment. For example, a user can require that avatars are stripped of any crime related paraphernalia on their avatars (e.g., virtual weapons) when in view and require that an avatar not be rendered in the user's environment if those requirement cannot be met.

In other embodiments, filtration module 110 receives the avatar filtration parameters in real-time, substantially real-time, and/or periodically captured location parameters associated with a user automatically. For example, computing device 104 can provide data from one or more sensors such that filtration module 110 can automatically determine the best avatar filtration parameters based on the local environment. In a more specific example, computing device 104 can relay geolocation data, camera images, videos, infrared sensor data, and demographic data to filtration module 110, and, in response, filtration module 110 can apply one or more algorithms to optimize avatar filtration parameters for a location.

Algorithms can include, but are not limited to, traditional algorithms and machine learning algorithms. Algorithms can be applied to any one or more steps in any manner to assist partially and/or wholly executing any objective. For example, a machine learning algorithm can be applied to historical user data to determine a best color scheme to select for one parameter of a set of location parameters.

In one embodiment, filtration module 110 can analyze historical data and current data only using traditional algorithms. For example, filtration module 110 can analyze the percentage of total play time dedicated to a particular game character to determine which modifications to a user's augmented reality environment to enable and disable particular features in the environment. In another example, filtration module 110 can determine that a location is frequently visited by children, determine one or more pop culture references most popular with the demographics of the location, and determine via social media data that most of the visitors attend the same church; in response to these determinations, filtration module 110 can determine that avatars that are not child-friendly should not be viewable to a particular user and also determine that avatars with child-friendly features should be amplified visually.

It is contemplated that each user can filter out any one or more avatars to be modified, made unviewable, restricted from a space, and/or any other manner of controlling avatars in a user's environment. As such, each user can have different views of the same environment, such as mixed reality, augmented reality, and/or virtual reality environments.

In another embodiment, filtration module 110 can analyze historical data and current data using machine learning algorithms, which include, but are not limited to, supervised learning classifiers, time-series analysis, and linear regression analysis.

For example, filtration module 110 can predict a change in the environment, such as the basketball league championships, and correspondingly predict that location parameters allowing for purchasable digital goods and emotes for avatars to be temporarily free to use will most effectively bring in more purely virtual avatars and more augmented reality avatars (e.g., where the user is actually in the real world location).

In a more specific example, filtration module 110 can review the historical user comments associated with a professional gamer's streaming videos and predict that the crowd will have a balance of males and females with a preference for a specific character in a video game and correspondingly prioritize entry of avatars fitting those preferences in an exclusive augmented reality environment.

In another example, a linear regression analysis can applied to the user's historical location data to predict what a user will do next (e.g., move to the fighting game section of a gaming convention) and those predictions can be used to apply predicted user parameters and predicted location parameters for the predicted user location in one hour. In a more specific example, a traditional algorithm can look at a user's followers and determine that he/she is famous and associated with a popular game, and a linear regression analysis can determine that the user usually goes to a specific restaurant after a tournament at the current user location. In response, filtration module 110 can update the augmented reality appearance of the restaurant to reflect the user's eSports team colors,

In yet another example, filtration module 110 can determine through current user data and public data that a first team beat a second team in a sporting event that the user is currently attending. By determining through traditional algorithms that the user is a fan of the second team and, through machine learning algorithms, that the user always goes to a particular bar after a loss, filtration module 110 can predict the next environment of the user to place a halo around the avatars of other fans of the user's team.

Filtration module 110 updates the location parameter with the avatar filtration parameters (step 504).

Filtration module 110 identifies an avatar within the target area (step 506).

Filtration module 110 can identify avatars in any manner. For example, filtration module 110 can identify avatars in an area using a combination of a smart phone camera, GPS data, social media data, and near field communications data.

Filtration module 110 determines whether the avatar meets the avatar filtration parameters (decision block 408).

Responsive to determining that the avatar meets the avatar filtration parameters (“YES” branch, decision block 408), filtration module 110 ends.

Responsive to determining that avatar does not meet the avatar filtration parameters (“NO” branch, decision block 408), filtration module 110 modifies a non-compliant avatar.

In one embodiment, filtration module 110 can change the appearance of a non-compliant avatar to meet the avatar filtration requirements. For example, filtration module 110 can remove any references to restricted items listed in the avatar filtration requirements, such as virtual weapons and virtual tattoos. In another example, filtration module 110 can replace the non-compliant avatar with a compliant avatar as viewed by the user, such as a generic avatar or a random character from a video game.

In another embodiment, filtration module 110 can remove the avatar from the user's view. For example, filtration module can remove the non-compliant avatar from the augment reality environment of the user. The user may still see a person in real-life, but the non-compliant avatar will not be overlaid on top of the person.

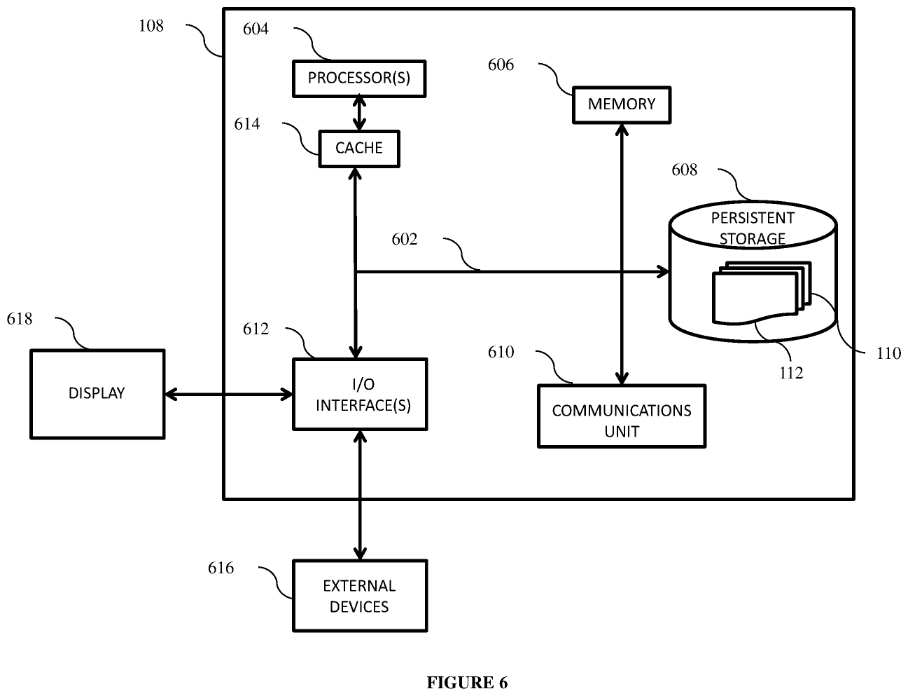

FIG. 6 depicts a block diagram of components of the server computer executing the filtration module 110 within the distributed data processing environment of FIG. 1. FIG. 6 is not limited to the depicted embodiment. Any modification known in the art can be made to the depicted embodiment.

In one embodiment, the computer includes processor(s) 604, cache 614, memory 606, persistent storage 608, communications unit 610, input/output (I/O) interface(s) 612, and communications fabric 602.

Communications fabric 602 provides a communication medium between cache 614, memory 606, persistent storage 608, communications unit 610, and I/O interface 612. Communications fabric 602 can include any means of moving data and/or control information between computer processors, system memory, peripheral devices, and any other hardware components.

Memory 606 and persistent storage 608 are computer readable storage media. As depicted, memory 606 can include any volatile or non-volatile computer storage media. For example, volatile memory can include dynamic random-access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 606 and persistent storage 608 are random access memory and a hard drive hardwired to computing device 604, respectively. For example, computing device 604 can be a computer executing the program instructions of filtration module 110 communicatively coupled to a solid-state drive and DRAM.

In some embodiments, persistent storage 608 is removable. For example, persistent storage 608 can be a thumb drive or a card with embedded integrated circuits.

Communications unit 610 provides a medium for communicating with other data processing systems or devices, including data resources used by computing device 104. For example, communications unit 610 can comprise multiple network interface cards. In another example, communications unit 610 can comprise physical and/or wireless communication links.

It is contemplated that filtration module 110, database 112, and any other programs can be downloaded to persistent storage 608 using communications unit 610.

In a preferred embodiment, communications unit 610 comprises a global positioning satellite (GPS) device, a cellular data network communications device, and short to intermediate distance communications device (e.g., Bluetooth®, near-field communications, etc.). It is contemplated that communications unit 610 allows computing device 104 to communicate with other computing devices 104 associated with other users.

Display 618 is contemplated to provide a mechanism to display information from filtration module 110 through computing device 104. In preferred embodiments, display 618 can have additional functionalities. For example, display 618 can be a pressure-based touch screen or a capacitive touch screen.

In yet other embodiments, display 618 can be any combination of sensory output devices, such as, for example, a speaker that communicates information to a user and/or a vibration/haptic feedback mechanism. For example, display 618 can be a combination of a touchscreen in the dashboard of a car, a voice command-based communication system, and a vibrating bracelet worn by a user to communicate information through a series of vibrations.

It is contemplated that display 618 does not need to be physically hardwired components and can, instead, be a collection of different devices that cooperatively communicate information to a user.

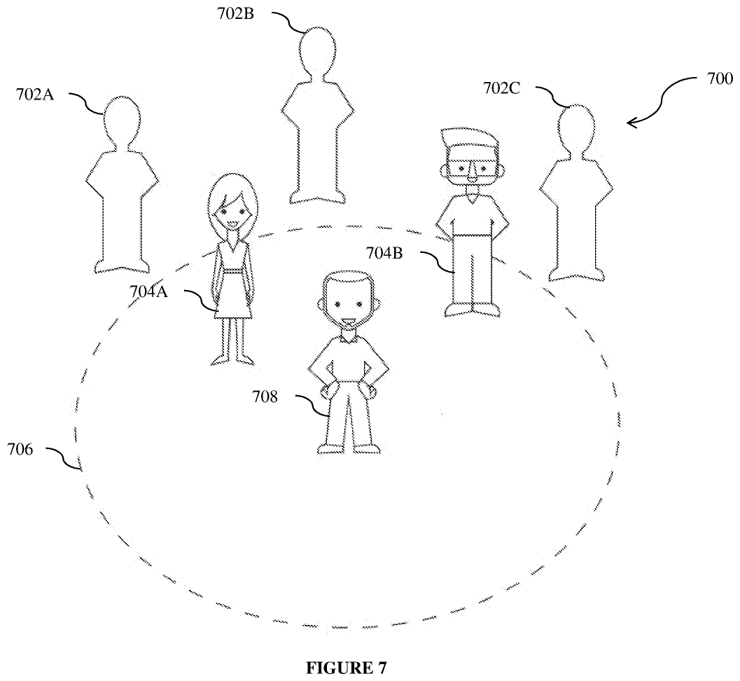

FIG. 7 is a representative diagram illustrating the filtration of users based on location parameters and avatar filtration parameters using a target area in augmented reality environment 700.

FIG. 7 depicts a modified augmented reality environment 700 based on the location and the surrounding non-user avatars. In the depicted embodiment, augmented reality environment 700 is displayed through user interface 106 of computing device 104. Augmented reality environment 700 depicts user 708, first non-user avatar 704A, and second non-user avatar 704B. Augmented reality environment 700 comprises target area 706 around user 708 and blocked avatars 702A-C.

It is contemplated that filtration module 110 can use environmental characteristics, depicted herein as a location, to gather the context of the user's environment. For example, environmental characteristics can include a time of day, a location, and a schedule of events for a venue, filtration module 110 can determine the theme and appropriate avatar and environment modifications for each user within 100 meters of user 708 based on one or more avatar filtration parameters.

Avatars are not limited to the depicted embodiment. It is contemplated that avatars can comprise any visual, auditory, and tactile elements. For example, avatar filtration parameters can include changes such as voice changers, color schemes, and environmental themes.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics are as follows: on-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a high level of abstraction (e.g., country, state, or data center). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (laaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of selected networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of using one or more computer processors to filter and modify avatars in an environment, comprising:
receiving an avatar filtration parameter;
updating location parameters with the avatar filtration parameter;
determining a physical target area about a user;
identifying an avatar of a second user in the target area;
determining whether the avatar meets the avatar filtration parameter; and
responsive to determining that the avatar does not meet at least one of the avatar filtration parameters, modifying the avatar to comply with all of the avatar filtration parameters.

2. The method of claim 1, wherein modifying the avatar to comply with the avatar filtration parameters comprises modifying an appearance of the avatar.

3. The method of claim 1, wherein modifying the avatar to comply with the avatar filtration parameters comprises modifying the abilities of an avatar.

4. The method of claim 1, wherein modifying the avatar to comply with the avatar filtration parameters comprises removing the avatar from a field of view of the user.

5. The method of claim 1, wherein the environment comprises a shared augmented reality environment comprising a set of multiple users that includes the user.

6. The method of claim 1, wherein the environment comprises a shared augmented reality environment, wherein each user views a tailored user environment.

7. The method of claim 1, wherein the environment comprises a shared virtual environment comprising a set of multiple users that includes the user.

8. The method of claim 1, wherein the environment comprises a shared virtual environment, wherein each user views a tailored user environment.

9. The method of claim 1, wherein the avatar modification is a tactile modification.

10. The method of claim 1, wherein the location parameter comprises user-submitted location data.

11. The method of claim 1, wherein the location parameter comprises crowd-sourced location data.

12. The method of claim 1, wherein modifying the avatar comprises modifying avatar functionality in the target area.
